(19) United States
(12) Patent Application Publication
(10) Pub. No.: US 2010/0038847 A1
(43) Pub. Date: Feb. 18, 2010

(54) TRANSMISSION FOR AN AUTOMATIC DOCUMENT FEEDER

(76) Inventors: Kevin Bokelman, San Diego, CA (US); Glenn W. Gaarder, Ramona, CA (US); Ryan M. Smith, San Diego, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/258,533

(22) Filed: Oct. 27, 2008

Related U.S. Application Data
(60) Provisional application No. 61/088,623, filed on Aug. 13, 2008.

(51) Int. Cl. B65H 5/00; H02K 7/116

(52) U.S. Cl. 271/264; 74/421 A

(57) ABSTRACT

An automatic document feeder transmission includes a single electric motor mounted on a chassis. Motor actuates a power input gear that is rotatably mounted on the chassis and has gear teeth. A swing arm, rotatably mounted to the chassis, pivots about a swing arm pivot axis through an arc of travel. Arm has central and distal ends, the latter having gear teeth formed therein. Driving and driven pinions, each having mutually intermeshing gear teeth, are rotatably mounted to the arm. Driven pinion gear teeth also intermesh with power input gear teeth. A paper stop is rotatably mounted on the chassis. A catch, disposed on the arm, is selectively engageable with a wire spring disposed adjacent portion(s) of the travel arc, wherein arm rotation is selectively stopped in one direction and allowed in an opposite direction. Arm selectively switches between three discreet feeder modes and selectively actuates the paper stop.

### BACKGROUND

The present disclosure relates generally to automatic document feeders, and more particularly to a transmission for an automatic document feeder.

Automatic document feeders are often used with document scanners and copiers. A document is drawn or picked from a stack of documents, fed onto glass of the scanner/copier, and then almost completely ejected before the next document is drawn/picked. Thus, three modes may be useful in the automatic document feeder: 1) pick, 2) feed without picking, and 3) eject. Additionally, a paper stop gate may be useful in enhancing pick performance and usability of the automatic document feeder.

Some existing designs for automatic document feeders use two or three electric motors to achieve the three automatic document feeder modes. Other designs use electromagnetic clutches, and solenoid actuators to allow reduction in the number of electric motors while providing the three modes of operation.

### BRIEF DESCRIPTION OF THE DRAWINGS

Features and advantages of embodiments of the present disclosure will become apparent by reference to the following detailed description and drawings, in which like reference numerals correspond to the same or similar, though perhaps not identical, components. For the sake of brevity, reference numerals having a previously described function may or may not be described in connection with subsequent drawings in which they appear.

FIG. 1 is a semi schematic side cut-away view of an embodiment of a transmission for an automatic document feeder;

FIG. 2 is a semi-schematic side cut-away view of a portion of an embodiment of the transmission for the automatic document feeder showing a swing arm between eject and pick positions with a wire spring engaging a catch and preventing rotation in the pick direction;

FIG. 3 is a semi-schematic side cut-away view of a portion of an embodiment of the transmission for the automatic document feeder showing the eject position;

FIG. 4 is a semi-schematic side cut-away view of a portion of an embodiment of the transmission for the automatic document feeder showing the swing arm between eject and pick positions with the wire spring sliding under the catch and allowing rotation in the pick direction;

FIG. 5 is a semi-schematic side cut-away view from the side opposite that shown in FIGS. 1-4, showing the swing arm between pick and eject positions while rotating in the eject direction;

FIG. 6 is a semi-schematic side cut-away view from the side opposite that shown in FIGS. 1-4, showing driven pinion gear teeth beginning to engage teeth of a section of a ring gear while the swing arm rotates in the eject direction;

FIG. 7 is a semi-schematic side cut-away view from the side opposite that shown in FIGS. 1-4, showing driven pinion gear teeth engaging teeth of the section of the ring gear while the swing arm gear teeth engage transfer shaft gear teeth;

FIG. 8 is a semi-schematic side cut-away view from the side opposite that shown in FIGS. 1-4, showing a paper stop in the paper stop position and the swing arm in the eject position;

FIG. 9 is a semi-schematic perspective cut-away view showing details of the catch and the wire spring;

FIG. 10 is a semi-schematic top cut-away view showing the wire loop in contact with the swing arm; and

FIG. 11 is a perspective view of a scanner/copier with an automatic document feeder.

### NOTATION AND NOMENCLATURE

Certain terms are used throughout the following detailed description and claims to refer to particular system components. As one skilled in the art will appreciate, producers of automatic document feeders may refer to a component by different names. This document does not intend to distinguish between components that differ in name but not function.

### DETAILED DESCRIPTION

Embodiments of a transmission for an automatic document feeder are disclosed herein. The transmission generally includes a single electric motor which advantageously enables the following three discreet modes: sheet/document pick mode, feed without picking mode, and eject mode. Generally, the single electric motor is not used in combination with other electric clutches or actuators. Furthermore, in an embodiment, a paper stop gate is activated by the transmission to improve pick performance without increasing the number of electric clutches or actuators used in the feeder.

Referring first to FIG. 11, an embodiment of a scanner/copier 100 having an automatic document feeder 20 operatively attached thereon is depicted. In an embodiment, the automatic document feeder 20 is an automatic photo feeder 21, which may be particularly suitable for photo paper. The automatic document feeder 20 includes a support chassis 30.

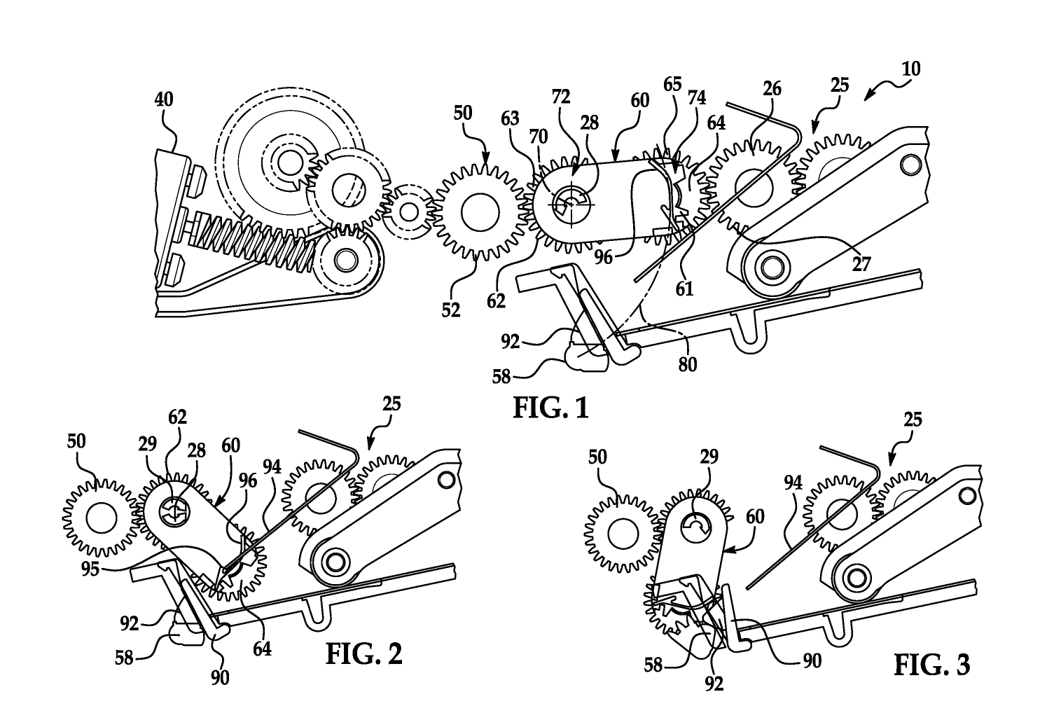

Referring now to FIG. 1, there is shown a semi-schematic side view of a transmission 10 for an automatic document feeder 20. A single electric motor 40 is mounted on the support chassis 30 (not shown in FIG. 1). The single electric motor 40 actuates a power input gear 50 that is rotatably mounted on the support chassis 30. Actuation of the power input gear 50 causes the power input gear 50 to rotate. Rotation of the power input gear 50 causes a driving pinion 62 to rotate because of mutually intermeshing power input gear teeth 52 and driving pinion gear teeth 63. Furthermore, rotation of driving pinion 62 causes driven pinion 64 to rotate. This is due to the driving pinion gear teeth 63 intermeshing with the driven pinion gear teeth 65.

Still referring to FIG. 1, the driving pinion 62 and the driven pinion 64 are rotatably mounted to a swing arm 60, which is rotatably mounted to the support chassis 30. The swing arm 60 is caused to rotate about a swing arm pivot axis 70 through a swing arm arc of travel 80 due, at least in part, to friction between the swing arm 60 and the driving pinion 62. The swing arm 60 has a central end 72 proximate the swing arm pivot axis 70 and a distal end 74 opposite to the central end 72. At least two swing arm gear teeth 61 are disposed at or formed in the distal end 74. As shown in FIG. 1, the swing arm 60 may be rotated in a pick direction 28 to a pick position where a pick transmission 25 is actuated by rotation of a pick transmission input drive gear 26 through the intermeshing of the driven pinion gear teeth 65 and the pick transmission input drive gear teeth 27. In this mode, the feeder 100 is able to pick a sheet or document from a stack of sheets/documents.

Referring now to FIG. 2, various portions of the transmission 10 are shown in the feed without pick mode. Transition into this mode from pick mode is accomplished by reversing the single electric motor 40 (shown in FIG. 1) from the direction that causes rotation of the driving pinion 62 in the pick direction 28, and causing the swing arm 60 to rotate a predetermined angle in the eject direction 29. When the motor 40 is in reverse, the swing arm 60 rotates in sympathy with the driving pinion 62 because of friction therebetween, and disengages from the pick transmission 25.

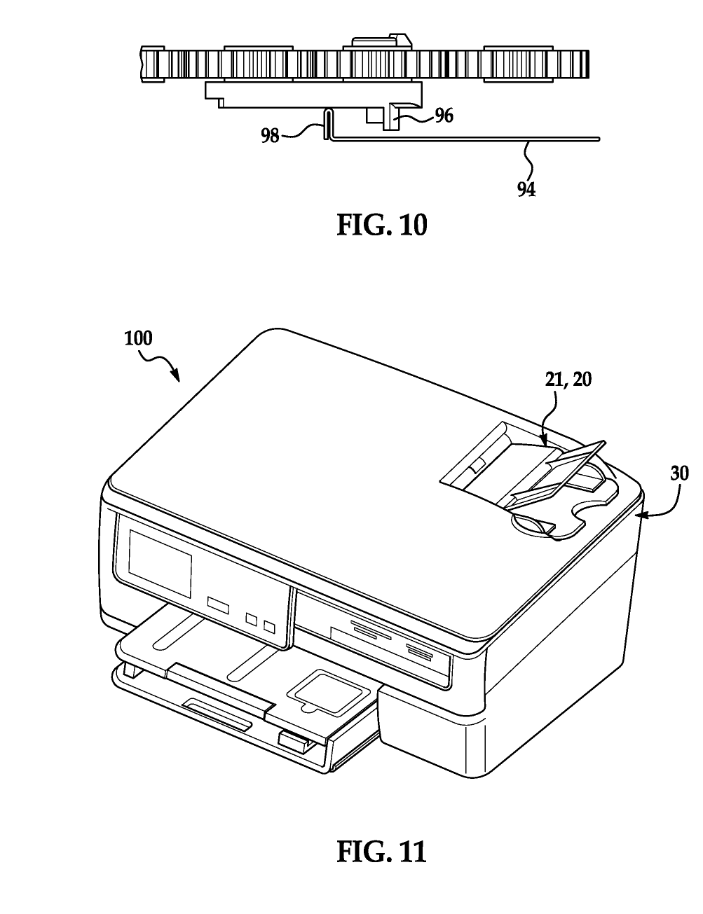

As the swing arm 60 rotates, a spring index 98 formed on an end of a wire spring 94 (see FIGS. 9 and 10) traverses a leading edge 97 of a catch 96 and snaps to engage a barb 95 at a predetermined angle on the swing arm arc of travel 80. The wire spring 94 may have a predetermined length, a predetermined diameter, and one or more bends along the length. The spring index 98 on the end of the wire spring 98 may include about a 180° bend (e.g., from about 170° to about 190° which has an inside bend radius less than or equal to the wire diameter. It is believed that this presents a substantially smooth surface to the swing arm 60 and catch 96, and substantially eliminates a tendency for a burr (not shown) on the end of the wire spring 94 to gouge the swing arm 60 and catch 96.

The swing arm 60 may continue to rotate in the eject direction 29, but if the single electric motor 40 changes (or is caused to change) direction, the rotation of the driving pinion 62 switches back to the pick direction 28. As such, the spring index 98 engagement with the barb 95 will selectively prevent rotation of swing arm 60, thus entering the feed without pick mode.

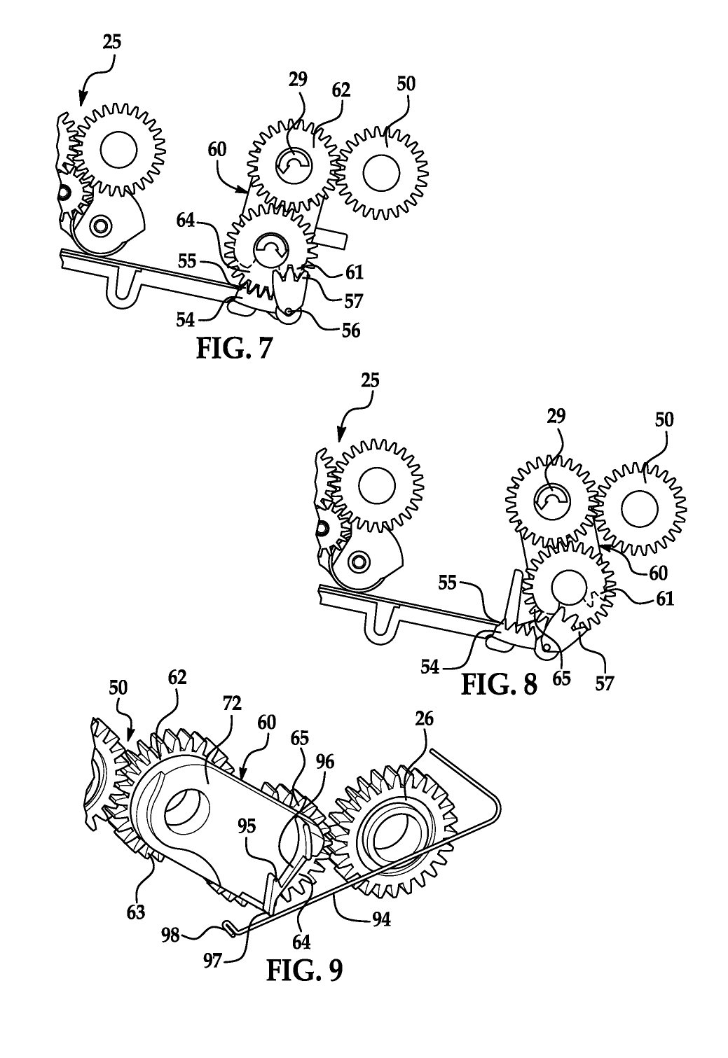

Referring now to FIGS. 3, 5, 6 and 7 together, in an embodiment, the swing arm 60 pivots in the eject direction 29 to a predetermined angle which causes the engagement of the driven pinion gear teeth 65 with the teeth of a section of a ring gear 55 fixedly mounted on the support chassis 30 (shown in FIG. 11). The engagement of the driven pinion gear teeth 65 with the teeth of the section of ring gear 55 provides sufficient force to pivot the swing arm 60. Furthermore, torque is provided by friction between the driving pinion 62 and the swing arm 60. The swing arm gear teeth 61 engage the transfer shaft gear teeth 57, thereby transferring rotation of the swing arm 60 into rotation of the paper stop transfer shaft 56 (see FIG. 7). The paper stop transfer shaft 56 is rotatably mounted to the support chassis 30. Rotation of the paper stop transfer shaft 56 causes a paper stop actuating cam 58 mounted on the paper stop transfer shaft 56 to rotate a paper stop 90 by actuating a paper stop cam follower 92 disposed on the paper stop 90. The paper stop actuating cam 58 and the paper stop cam follower 92 are configured to substantially prevent force applied to the paper stop 90 from causing the paper stop actuating cam 58 to rotate. For example, if a stack of paper is forced against the paper stop 90, the paper stop 90 will not cause the paper stop transfer shaft 56 to rotate or the swing arm gear teeth 61 engaged therewith to move in the pick direction 28. In this embodiment, the feeder 100 is in eject mode.

Referring now to FIG. 8, when the swing arm 60 rotates in the eject direction 29 to a predetermined angle, the swing arm gear teeth 61 disengage from the transfer shaft gear teeth 57 and the driven pinion gear teeth 65 disengage from the teeth of the section of ring gear 55, thereby allowing the driven pinion 64 to rotate freely.

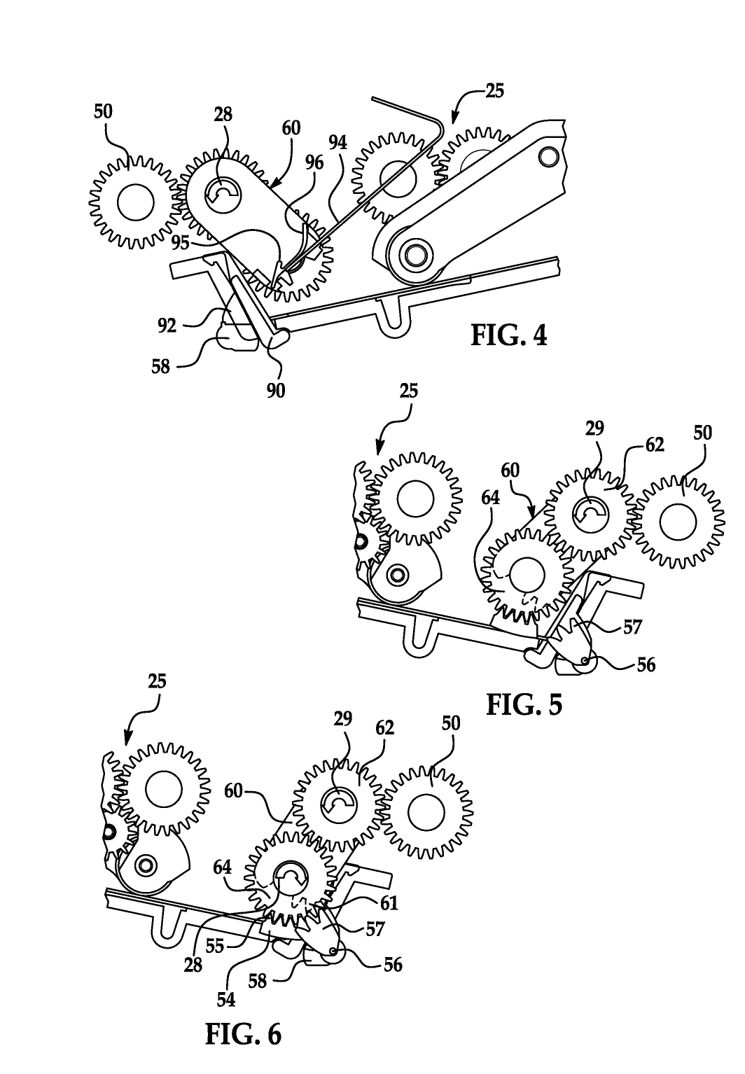

Referring now to FIG. 4, after the swing arm 60 has rotated in the eject direction beyond contact between a wire spring 94 and the catch 96, the catch 96 is disposed on the swing arm 60 and is configured to deflect the wire spring 94 as rotation of the swing arm 60 in the pick direction 28 brings the wire spring 94 into contact with the catch 96. It is to be understood that by deflecting the wire spring 94, the rotation of the swing arm 60 in the pick direction 28 is not stopped by interaction of the wire spring 94 and catch 96. The selective engagement of the catch with the wire spring enables rotation of the swing arm 60 to be selectively stopped in one direction and selectively allowed in the opposite direction.

The terms “mount”, “mounted” and/or “mounting” are broadly defined herein to encompass a variety of divergent connected arrangements and assembly techniques. These arrangements and techniques include, but are not limited to (1) the direct connection between one component and another component with no intervening components therebetween; and (2) the connection of one component and another component with one or more components therebetween, provided that the one component being “mounted to” the other component is somehow in operative communication with the other component (notwithstanding the presence of one or more additional components therebetween).

While several embodiments have been described in detail, it will be apparent to those skilled in the art that the disclosed embodiments may be modified. Therefore, the foregoing description is to be considered exemplary rather than limiting.

What is claimed is:

1. A transmission for an automatic document feeder, comprising:
a support chassis;
a single electric motor mounted on the support chassis;
a power input gear having gear teeth, the power input gear actuated by the single electric motor and rotatably mounted on the support chassis;
a swing arm rotatably mounted to the support chassis so as to pivot about a swing arm pivot axis through a swing arm arc of travel, the swing arm having a central end and a distal end and a plurality of swing arm gear teeth formed into the distal end thereof;
a driving pinion and a driven pinion rotatably mounted to the swing arm, the driving pinion and the driven pinion each having mutually intermeshing gear teeth, the driving pinion gear teeth also intermeshing with the power input gear teeth;
a paper stop rotatably mounted on the support chassis;
a wire spring disposed adjacent at least a portion of the swing arm arc of travel; and
a catch disposed on the swing arm, the catch selectively engageable with the wire spring, thereby selectively stopping rotation of the swing arm in one direction while allowing rotation of the swing arm in an opposite direction;
wherein the swing arm selectively switches the automatic document feeder between three discreet modes and selectively actuates the paper stop.

2. The transmission as defined in claim 1, further comprising a section of ring gear fixedly mounted to the support chassis and having gear teeth, the gear teeth of the section of ring gear intermeshing with the driven pinion gear teeth in at least a portion of the swing arm arc of travel.

3. The transmission as defined in claim 1, further comprising a paper stop transfer shaft rotatably mounted on the support chassis and having gear teeth formed thereon, the transfer shaft gear teeth intermeshing with the plurality of swing arm gear teeth.

4. The transmission as defined in claim 3, further comprising a paper stop actuating cam disposed on the paper stop transfer shaft, the paper stop actuating cam engageable with a paper stop cam follower operatively disposed on the paper stop.

5. The transmission as defined in claim 1 wherein the automatic document feeder is an automatic photo feeder.

6. The transmission as defined in claim 1, the wire spring including:
a predetermined length of spring wire having a wire diameter and one or more permanent bends in the wire spring; and
a spring index on an end of the wire spring, wherein the spring index includes a substantially 180 degree bend having an inside bend radius less than or equal to the wire diameter, thereby presenting a substantially smooth surface to the swing arm and the catch, and substantially eliminating a tendency for a burr on the end of the wire spring from gouging the swing arm and the catch.

7. The transmission as defined in claim 1 wherein the three discreet modes include a pick mode, a feed without pick mode, and an eject mode.

8. The transmission as defined in claim 7 wherein the one direction is a pick direction, and the opposite direction is an eject direction.

9. The transmission as defined in claim 8 wherein the swing arm switches the automatic document feeder to the pick mode by rotating the swing arm in the pick direction to a pick position, and the driven pinion engages a pick transmission input drive gear.

10. The transmission as defined in claim 9 wherein the swing arm switches the automatic document feeder to the feed without pick mode by rotating the swing arm a predetermined angle in the eject direction, thereby disengaging the driven pinion from the pick transmission input drive gear and selectively preventing the engagement of the pick transmission input drive gear by the driven pinion by engaging the catch with the wire spring upon subsequent reversal of the swing arm rotation to the pick direction.

11. The transmission as defined in claim 2, further comprising a paper stop transfer shaft rotatably mounted on the support chassis and having gear teeth formed thereon, the transfer shaft gear teeth intermeshing with the plurality of swing arm gear teeth.

12. The transmission as defined in claim 11, further comprising a paper stop actuating cam disposed on the paper stop transfer shaft, the paper stop actuating cam engageable with a paper stop cam follower operatively disposed on the paper stop.

13. The transmission as defined in claim 12, wherein the three discreet modes include a pick mode, a feed without pick mode, and an eject mode.

14. The transmission as defined in claim 13 wherein the one direction is a pick direction, and the opposite direction is an eject direction.

15. The transmission as defined in claim 14 wherein the swing arm switches the automatic document feeder to the pick mode by rotating the swing arm in the pick direction to a pick position, and the driven pinion engages a pick transmission input drive gear.

16. The transmission as defined in claim 15 wherein the swing arm switches the automatic document feeder to the feed without pick mode by rotating the swing arm a predetermined angle in the eject direction, thereby disengaging the driven pinion from the pick transmission input drive gear and selectively preventing the engagement of the pick transmission input drive gear by the driven pinion by engaging the catch with the wire spring upon subsequent reversal of the swing arm rotation to the pick direction.

17. The transmission as defined in claim 14 wherein the automatic document feeder switches to the eject mode by rotating the swing arm in the eject direction toward a predetermined eject position, and the swing arm gear teeth engage the transfer shaft gear teeth and rotate the paper stop transfer shaft, thereby rotating the paper stop to a paper stop position by actuating the paper stop cam follower with the paper stop actuating cam.

18. The transmission as defined in claim 17 wherein the driven pinion engages the section of ring gear while the swing arm gear teeth engage the transfer shaft gear teeth, thereby producing sufficient force to rotate the paper stop.

19. The transmission as defined in claim 17 wherein the driven pinion is disengaged from the section of ring gear when the swing arm is in the predetermined eject position.

20. The transmission as defined in claim 16 wherein the paper stop actuating cam and the paper stop cam follower are configured to substantially prevent force applied to the paper stop from causing the paper stop cam follower to force the paper stop actuating cam to rotate.
